(19) United States
(12) Patent Application Publication
(10) Pub. No.: US 2010/0023608 A1
(43) Pub. Date: Jan. 28, 2010

(54) DEVICE SETTING ALTERATION SYSTEM, NETWORK DEVICE, AND STORAGE MEDIUM

(75) Inventor: Hiroyuki Hanano, Osaka (JP)

Correspondence Address: K&L Gates LLP, P.O. Box 1135, CHICAGO, IL, 60690, US

(73) Assignee: KYOCERA MITA CORPORATION, Osaka (JP)

(21) Appl. No.: 12/465,239

(22) Filed: May 13, 2009

(30) Foreign Application Priority Data
Jul. 25, 2008 (JP) 2008-192076
Jul. 25, 2008 (JP) 2008-192078

(51) Int. Cl. G06F 15/177

(52) U.S. Cl. 709/221

(57) ABSTRACT

A device setting alteration system comprises a plurality of network devices connected to one another via a network. Each of the plurality of network devices comprises: a device main body that requests a setting alteration with respect to its network device that comprises the device main body itself; a data analysis unit that determines whether or not a setting alteration is being performed through another device main body of another network device when the device main body requests the setting alteration; a processing execution unit that uses, when the data analysis unit determines that a setting alteration is not being performed through another device main body, the setting alteration performed through the device main body upon its network device; and a network communication unit that transmits a content of the setting alteration to another network device.

### INCORPORATION BY REFERENCE

This application is based upon and claims the benefit of priority from the corresponding Japanese Patent Application No. 2008-192076, filed Jul. 25, 2008, and Japanese Patent Application No. 2008-192078, filed Jul. 25, 2008, the entire contents of which is incorporated herein by reference.

### BACKGROUND

1. Field of the Invention

The present invention relates to: device setting alteration systems capable of altering a setting item for a network device; network devices; and storage medium.

2. Description of the Related Art

In general, a device setting alteration system is connected to a network such as a LAN (local area network) to which a network device (for example, image forming apparatus) and a client device (for example, personal computer (PC)) are connected. The image forming apparatus can provide various kinds of service in response to a request issued by a PC.

Herein, a setting alteration with respect to the image forming apparatus can be executed through an operation panel provided thereto and also from the PC by use of an application.

In the situation where a plurality of PCs are connected to the network, when one PC performs a setting alteration, a setting alteration performed by another PC is rejected.

The related art described above merely indicates a relationship between the setting alteration performed by one PC and the setting alteration performed by another PC.

### SUMMARY

A device setting alteration system according to an embodiment of the present invention comprises a plurality of network devices connected to one another via a network. Each of the plurality of network devices comprises a device main body, a data analysis unit, a processing execution unit, and a network communication unit. Herein, the device main body requests a setting alteration with respect to its network device that comprises the device main body itself. When the device main body requests the setting alteration, the data analysis unit determines whether or not a setting alteration is being performed through another device main body of another network device. When the data analysis unit determines that a setting alteration is not being performed through another device main body, the processing execution unit uses the setting alteration performed through the device main body upon its network device. The network communication unit transmits a content of the setting alteration to another network device.

A network device according to an embodiment of the present invention is connected to another network device via a network, and comprises a device main body, a data analysis unit, a processing execution unit, and a network communication unit. Herein, the device main body requests a setting alteration with respect to its network device that comprises the device main body itself. When the device main body requests the setting alteration, the data analysis unit determines whether or not a setting alteration is being performed through another device main body of another network device. When the data analysis unit determines that a setting alteration is not being performed through another device main body, the processing execution unit uses the setting alteration performed through the device main body upon its network device. The network communication unit transmits a content of the setting alteration to another network device.

A storage medium according to an embodiment of the present invention is a computer-readable storage medium, which stores therein a device setting alteration program that causes a computer of a network device connected to another network device via a network to execute a setting alteration with respect to the network device. The device setting alteration program causes the computer to execute the steps of: requesting a setting alteration with respect to the network device; determining whether or not the setting alteration is being performed through another device main body of another network device when the setting alteration with respect to its network device is requested; reflecting, when it is determined that a setting alteration is not being performed through another device main body, the setting alteration performed through a device main body upon the network device; and transmitting a content of the setting alteration to another network device.

A device setting alteration system according to another embodiment of the present invention comprises a device main body, a client device, a priority judgment unit, and a processing execution unit. Herein, the device main body requests a setting alteration with respect to a network device. The client device is connected to the network device via a network, and requests a setting alteration with respect to the network device. The priority judgment unit determines whether a setting alteration performed through the device main body or a setting alteration performed through the client device is prioritized based on a content of the setting alteration with respect to the network device. The processing execution unit prevents another setting alteration when one setting alterations is determined to be prioritized by the priority judgment unit.

A network device according to another embodiment of the present invention comprises a priority judgment unit and a processing execution unit, and is connected to a client device via a network. The priority judgment unit determines which eihter a setting alteration performed through the device main body or a setting alteration performed through the client device is prioritized based on a content of the setting alteration with respect to the network device. The processing execution unit prevents another setting alteration when one setting alteration is determined to be prioritized by the priority judgment unit.

A storage medium according to another embodiment of the present invention stores a computer-readable device setting alteration program that causes a computer of a network device to execute a setting alteration with respect to the network device, the network device comprising a device main body and being connected to a client device via a network. The device setting alteration program causes the computer to execute the steps of: prioritizing either the setting alteration performed through the device main body or the setting alteration performed through the client device connected via the network based on a content of the setting alteration with respect to the network device; and preventing another setting alteration when the one setting alterations is prioritized.

Additional features and advantages are described herein, and will be apparent from the following Detailed Description and the figures.

### BRIEF DESCRIPTION OF THE FIGURES

In the accompanying drawings:

FIG. 1 illustrates a design of a device setting alteration system according to an embodiment of the present invention;

FIG. 2 illustrates a schematic configuration diagram of an MFP illustrated in FIG. 1;

FIG. 3 illustrates a flowchart with respect to a setting alteration performed by a controller illustrated in FIG. 1;

FIG. 4 illustrates a flowchart with respect to a setting alteration performed by the controller illustrated in FIG. 1;

FIG. 5 illustrates a flowchart with respect to communications for the setting content performed by the controller illustrated in FIG. 1;

FIG. 6 illustrates a design of a device setting alteration system according to another embodiment of the present invention;

FIG. 7 illustrates a schematic configuration diagram of an MFP illustrated in FIG. 6;

FIG. 8 illustrates a flowchart with respect to a setting alteration performed by a controller illustrated in FIG. 6; and

FIG. 9 illustrates a flowchart with respect to another example of the setting alteration.

### DETAILED DESCRIPTION

In most offices and the like using a plurality of network devices, the setting content is shared in order to allow commonality of operability among the plurality of network devices.

A client device makes a setting alteration request generally by collectively transmitting the alteration content of a setting (which may involve a plurality of setting items) to the network device from the client device. In this situation, only when receiving the setting alteration request made by the client device and reflecting the alteration content, the network device has to prevent a setting alteration request made by another client device.

However, in a setting alteration performed through an operation panel of the network device, each time one setting item is altered, the alteration content thereof is used upon its network device. Therefore, when there is a plurality of setting items to be altered, a setting alteration request occurs for each setting item. In a similar manner, a setting alteration request made by another network device occurs for each altered setting item, and is transmitted from another network device to its network device. This results in idle time to occur between a given setting alteration request and the subsequent setting alteration request that are transmitted from another network device. If a setting alteration request made by the operation panel of its network device is accepted during the idle time, setting alterations that have been requested on different purposes may lead to confusion. This holds true in a situation where a setting alteration request made by another network device is accepted during the idle time that occurs between setting alteration requests made by the operation panel.

Further, the sharing of the setting content is generally performed by a particular manager. In this situation, the manager performs a setting alteration through either the operation panel of the network device or the client device. Therefore, it is necessary not only to avoid the confusion of the setting alterations as described above, but also to prioritize the setting alteration performed through the device operated by the manager.

It is desirable that the description above be taken into consideration with respect to the relationship between the setting alteration performed through the operation panel and the setting alteration performed through another network device or the client device (in a different manner from a relationship between the client device and another client device).

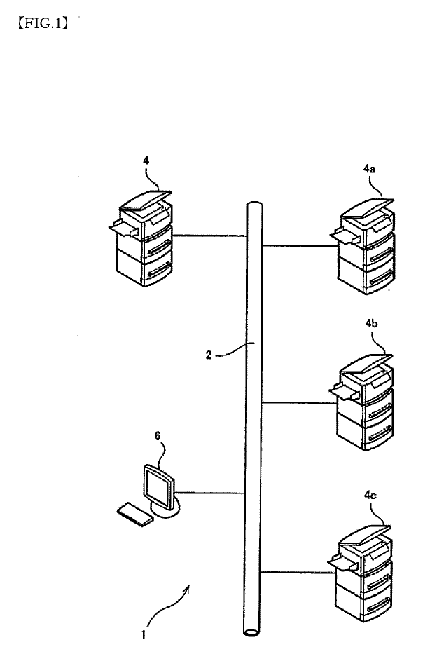

FIG. 1 illustrates an embodiment of a device setting alteration system of the present invention. Specifically illustrated is a system 1 designed by using, for example, a network 2 such as a LAN, in which four image forming apparatuses (network devices) 4, 4a, 4b, and 4c and a remote PC (client device) 6 are each connected to the network 2.

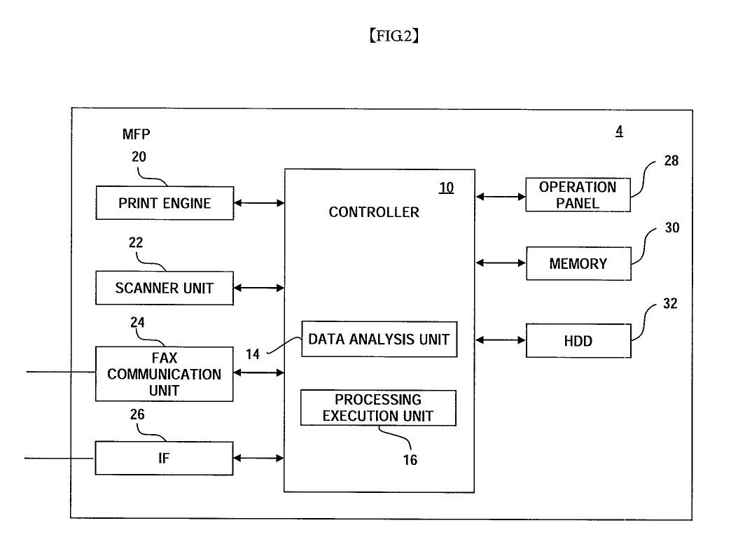

FIG. 2 is a schematic configuration diagram of the image forming apparatus. The image forming apparatus is a multiple function peripheral (MFP). Herein, the MFPs 4, 4a, 4b, and 4c have the same configuration. Hereinafter, unless otherwise noted, the description is made with reference to the configuration of the MFP 4. The MFP 4 is connected to the network 2 using a network interface 26, and is further connected to a public line. In addition, the MFP 4 executes various kinds of operation according to instructions issued by a program.

The MFP 4 includes a controller 10. The MFP 4 further includes an HDD 32, the network interface 26, a FAX communication unit 24, a scanner unit 22, a print engine 20, an operation panel 28, and a memory 30, which are each connected to the controller 10 via a bus.

The HDD 32 is a hard disk drive, and successively saves various electronic files such as data read by the scanner unit 22, data transmitted from the remote PC 6, and data received by the FAX communication unit 24. In addition to the above-mentioned various electronic files, the HDD 32 saves an address book, customer information, and the like of each user that operates the remote PC 6.

The network interface 26 uses a protocol such as Simple Network Protocol (SNMP) and Simple Object Access Protocol (SOAP) to perform communications for various kinds of data via the network 2. For example, the network interface 26 receives the data transmitted from the remote PC 6. In addition, the network interface 26 transmits the data saved on the HDD 32 to a communication counterpart via the network 2.

The FAX communication unit 24 is connected to a telephone line or to the network 2, and receives data transmitted by facsimile from outside of the MFP 4. In contrast, the FAX communication unit 24 transmits the data saved on the HDD 32 by facsimile to the communication counterpart.

The scanner unit 22 includes an automatic document feeder (ADF) for conveying the document to an image reading position, and sequentially reads images from a plurality of sheets of the document.

The print engine 20 prints the data saved on the HDD 32 onto a paper sheet.

Note that the MFP 4 is connected to a paper sheet supply unit (not shown) for supplying a paper sheet, an image forming unit (not shown) for transferring an image onto the paper sheet, a postprocessing device (not shown) for sorting, punching, or stapling the paper sheet onto which the image has been transferred, and the like.

The operation panel 28 (device main body) includes buttons for touch-operations. The operation panel 28 accepts the user's touch-operations to provide the remote PC 6 and the like with various kinds of service. In addition, the operation panel 28 notifies the controller 10 of the content of the user's operation that has been accepted by the operation panel 28. Herewith, the operation panel 28 is able to request the setting alteration for the MFP 4 to the controller 10. Further, the operation panel 28 displays a message for the user by using character information, a guidance image, and the like.

Note that examples of the setting alterations include updating of, deleting of, and the addition of an email address included in the address book or a customer telephone number included in the customer information, and the alteration of initial settings of a device.

The memory 30 includes a read only memory (ROM), an erasable programmable read only memory (EPROM), and a random access memory (RAM), and stores therein setting data used in printing, a device setting alteration program, and other such various kinds of program.

The various kinds of operations of MFP 4 are controlled by the controller 10. The controller 10 functions as a computer, and includes hardware resources such as a central processing unit (CPU). In addition, the controller 10 uses the hardware resources to execute a predetermined program, and operates the print engine 20, the scanner unit 22, and the FAX communication unit 24 which are described above.

The controller 10 includes a data analysis unit 14 and a processing execution unit 16. The controller 10 according to this embodiment of the present invention uses the content of the setting alteration performed with respect to the MFP 4 upon the MFP 4.

Specifically, the controller 10 receives a setting alteration request made by the operation panel 28 (aforementioned device main body) of the MFP (aforementioned network device) 4 via the bus. Further, the controller 10 also receives a setting alteration request made by the operation panel (aforementioned another device main body (not shown) corresponding to the operation panel 28 of the MFP 4) of the MFP 4a, 4b, or 4c (another MFP as aforementioned another device) via the network interface 26. Further, the controller 10 transmits the setting alteration request used upon the MFP 4 to the MFP 4a, 4b, or 4c. Herein, the setting alteration requests made by the operation panel 28 of the MFP 4 and the operation panel of the MFP 4a, 4b, or 4c include a command to perform a setting alteration, an identifier of a setting item to be altered, and a setting content thereof (such as a setting value and a setting character string).

The data analysis unit 14 of the controller 10 monitors whether or not there is currently a setting alteration request made by the operation panel 28 of the MFP 4 or the operation panel of the MFP 4a, 4b, or 4c, and outputs the monitoring result to the processing execution unit 16.

Subsequently, based on the monitoring result outputted by the data analysis unit 14, the processing execution unit 16 uses the setting content included in the setting alteration request made by the operation panel 28 of the MFP 4 or the operation panel of the MFP 4a, 4b, or 4c upon the MFP 4. Herein, while one of the setting alterations through the operation panel 28 of the MFP 4 and the operation panel of the MFP 4a, 4b, or 4c is being performed, the processing execution unit 16 prevents the other setting alteration.

Note that “the setting alteration performed through the operation panel 28” represents the setting content included in the setting alteration request made by the operation panel 28 upon the MFP 4 the setting item targeted by the setting alteration request. In the same manner, “the setting alteration is performed through the operation panel of the MFP 4a, 4b, or 4c” represents the setting content included in the setting alteration request made by the operation panel of the MFP 4a, 4b, or 4c upon the MFP 4 with respect to the setting item targeted by the setting alteration request.

Hereinafter, description is made of an operation of the MFP 4 having the above-mentioned configuration according to this embodiment of the present invention.

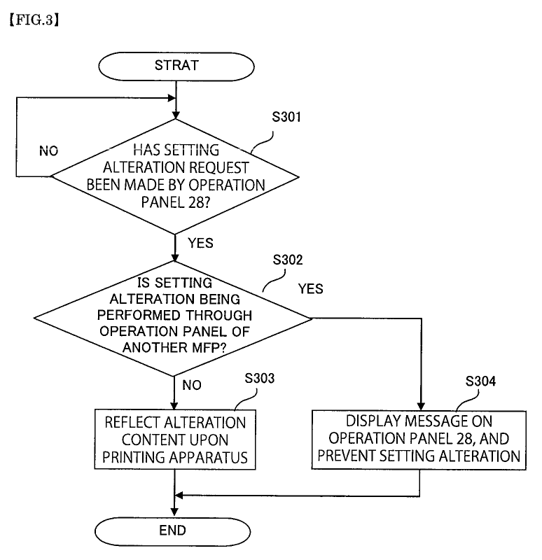

FIG. 3 is a flowchart illustrating a process for the setting alteration with respect to the MFP 4, which the device setting alteration program causes the controller 10 to execute, in a situation where a setting alteration request is made by the operation panel 28 with respect to the MFP 4.

First, in Step S301 of FIG. 3, the data analysis unit 14 waits until a setting alteration request made by the operation panel 28 of the MFP 4 is received. When the setting alteration request made by the operation panel 28 is received, the procedure advances to Step S302.

Subsequently, in Step S302, the data analysis unit 14 determines whether or not a setting alteration is being performed through the operation panel of the MFP 4a, 4b, or 4c with respect to the MFP 4. When it is determined that the setting alteration is not being performed through the operation panel of the MFP 4a, 4b, or 4c, that is, when the determination results in “NO” the procedure advances to Step S303.

Note that the phrase “a setting alteration is being performed through the operation panel of the MFP 4a, 4b, or 4c” indicates that a setting alteration based on a setting alteration request from the operation panel of the MFP 4a, 4b, or 4c is being performed by the processing execution unit 16. More specifically, the phrase indicates a situation where a setting alteration request is intermittently received by the controller 10 from the operation panel of the MFP 4a, 4b, or 4c before and after the current setting alteration request received by the controller 10 from the operation panel 28, and the setting content in the setting alteration request is used by the processing execution unit 16 upon the MFP 4. In this embodiment of the present invention, the phrase indicates that when a setting alteration request is received from the operation panel 28, a predetermined time period (for example, 1 minute) has not elapsed since the setting alteration request was received from the operation panel of the MFP 4a, 4b, or 4c (excluding a setting alteration request whose setting content has not been used upon the MFP 4). This case included a situation where the predetermined time period has not elapsed since the occurrence of only one setting alteration request received from the operation panel of the MFP 4a, 4b, or 4c. However, there is a possibility that the subsequent setting alteration request may be transmitted from the operation panel of the MFP 4a, 4b, or 4c within the predetermined time period. Therefore, in this embodiment of the present invention, the data analysis unit 14 recognizes such a situation as “setting alteration being performed through the operation panel of the MFP 4a, 4b, or 4c”.

In Step S303, the processing execution unit 16 uses the content of the setting alteration performed through the operation panel 28 upon the MFP 4. For example, the processing execution unit 16 changes the setting content with respect to the setting item such as altering, deleting, or adding to the address book or the customer information. For example, updating, deleting, or adding an email address included in the address book within the HDD 32 or a customer telephone number included in the customer information within the HDD 32 is performed.

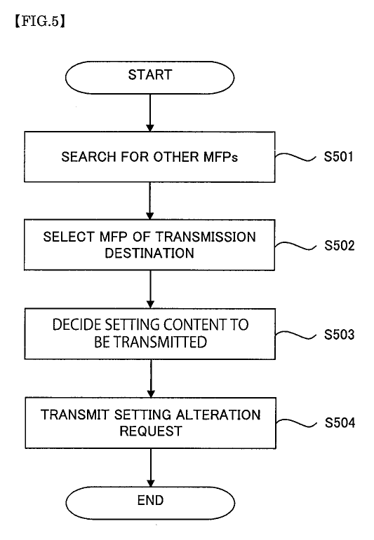

Further in Step S303, the processing execution unit 16 uses the setting alteration upon the MFP 4, and then generates a setting alteration request. The processing execution unit 16 transmits the setting alteration request to the MFP 4a, 4b, or 4c connected via the network 2, and the process is terminated. The transmission of the setting alteration request is described later in detail with reference to FIG. 5.

Note that the MFP 4a, 4b, or 4c that receives the setting alteration request transmitted herein makes the determination in Step S302 and in Step S401 of FIG. 5, which is described later, based on the setting alteration request.

Meanwhile, in Step S302, when the data analysis unit 14 determines that the setting alteration is being performed through the operation panel of the MFP 4a, 4b, or 4c, that is, when the determination results in “YES” the procedure advances to Step S304.

In Step S304, the processing execution unit 16 prevents the setting alteration performed through the operation panel 28. Further, the processing execution unit 16 displays a message that reads, for example, “a setting alteration is currently being performed through the remote PC” on the operation panel 28 to prompt the user to abandon the setting alteration performed through the operation panel 28, and the process is terminated.

In Step S304, the processing execution unit 16 prevents the setting alteration performed through the operation panel 28. Further, the processing execution unit 16 displays a message that reads, for example, “a setting alteration is currently being performed through another MFP” on the operation panel 28 to prompt the user to abandon the setting alteration performed through the operation panel 28, and the process is terminated.

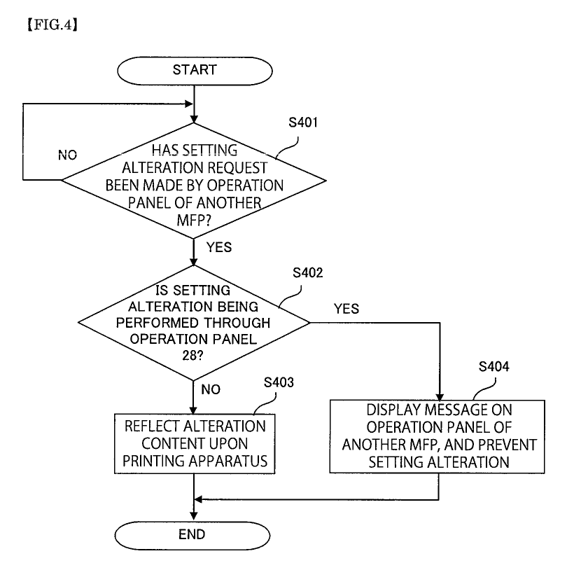

FIG. 4 is a flowchart illustrating a process for the setting alteration with respect to the MFP 4, wherein the device setting alteration program causes the controller 10 of the MFP 4 to execute, in a situation where a setting alteration request is made by the operation panel of the MFP 4a, 4b, or 4c with respect to the MFP 4.

First, in Step S401 of FIG. 4, the data analysis unit 14 waits until a setting alteration request, such as updating, deleting, or adding an email address included in the address book or a customer telephone number included in the customer information, made by the operation panel of the MFP 4a, 4b, or 4c is received. When the setting alteration request made by the operation panel of the MFP 4a, 4b, or 4c is received, the procedure advances to Step S402.

Subsequently, in Step S402, the data analysis unit 14 determines whether or not a setting alteration is being performed through the operation panel 28 with respect to the MFP 4. When it is determined that the setting alteration is not being performed through the operation panel 28, that is, when the determination results in “NO” the procedure advances to Step S403.

Note that the phrase “a setting alteration is being performed through the operation panel 28” indicates that a setting alteration based on a setting alteration request from the operation panel 28 is being performed by the processing execution unit 16. More specifically, the phrase indicates a state where a setting alteration request is intermittently received by the controller 10 from the operation panel 28 before and after the current setting alteration request received by the controller 10 from the operation panel of the MFP 4a, 4b, or 4c, and the setting content in the setting alteration request is used by the processing execution unit 16 upon the MFP 4. In this embodiment of the present invention, the phrase indicates that when there is a setting alteration request received from the operation panel of the MFP 4a, 4b, or 4c, a predetermined time period (for example, 1 minute) has not elapsed since the setting alteration request was received from the operation panel 28 (excluding a setting alteration request whose setting content has not been used upon the MFP 4). This situation includes the case where the predetermined time period has not elapsed since the occurrence of only one setting alteration request made by the operation panel 28. However, it is possible that the subsequent setting alteration request may be transmitted from the operation panel 28 within the predetermined time period, and hence in an embodiment of the present invention, the data analysis unit 14 recognizes such a case as “the setting alteration is being performed through the operation panel 28”.

In Step S403, the processing execution unit 16 uses the content of the setting alteration performed through the operation panel of the MFP 4a, 4b, or 4c upon the MFP 4. For example, the processing execution unit 16 changes the setting content in terms of the setting item such as altering, deleting, or adding the address book or the customer information. For example, updating, deleting, or adding an email address included in the address book within the HDD 32 or a customer telephone number included in the customer information within the HDD 32 is performed.

Further in Step S403, the processing execution unit 16 uses the setting alteration upon the MFP 4, and then generates a setting alteration request. The network interface 26 transmits the setting alteration request to the MFP 4a, 4b, or 4c connected via the network 2, and the process is terminated. The transmission of the setting alteration request is described later in detail with reference to FIG. 5.

Note that the MFP 4a, 4b, or 4c that has received the setting alteration request transmitted herein makes a determination in Step S302 and in Step S401 of FIG. 5 described later based on the setting alteration request.

Meanwhile, in Step S402, when the data analysis unit 14 determines that the setting alteration is being performed through the operation panel 28, that is, when the judgment results in “YES” the procedure advances to Step S404.

In Step S404, the processing execution unit 16 prevents the setting alteration performed through the operation panel of the MFP 4a, 4b, or 4c. Further, the processing execution unit 16 generates a display request to display a message to the effect that the setting alteration has been prevented. The network interface 26 transmits the display request to the MFP 4a, 4b, or 4c, which has been prevented from performing the setting alteration, and the process is terminated.

The MFP 4a, 4b, or 4c that has received the display request displays the message that reads, for example, “a setting alteration is currently being performed by another MFP” on its operation panel, to prompt the user to abandon the setting alteration performed through the operation panel 28.

Note that in Steps S303 and S403 described above, the processing execution unit 16 prevents a new setting alteration while reflecting the setting alteration. The processing execution unit 16 notifies a transmission source of the setting alteration request corresponding to the prevented setting alteration that the setting alteration has been prevented as in Step S304 or S404.

According to the above description, while the setting alteration is being performed through the operation panel 28 of the MFP 4, the setting alteration performed through the operation panel of another MFP 4a, 4b, or 4c is prevented; and in contrast, while the setting alteration is being performed through the operation panel of the MFP 4a, 4b, or 4c, the setting alteration performed through the operation panel 28 of the MFP 4 is prevented. Therefore, the MFP according to this embodiment of the present invention has overcome the problem that while a given user is performing a setting alteration, the setting is changed by another user.

Hereinabove, a description of the processes executed on the MFP 4 was made by referring to FIGS. 3 and 4, but the same process can be executed on the MFP 4a, 4b, or 4c.

FIG. 5 is a flowchart illustrating a process performed when a setting alteration request is transmitted to the MFP 4a, 4b, or 4c after the MFP 4 has used the setting content upon the MFP 4 in Step S303 or S403 described above.

After the setting content has been used upon the MFP 4, in Step S501 of FIG. 5, the network interface 26 of the MFP 4 searches for other MFPs, and retrieves the MFPs 4a, 4b, and 4c.

Subsequently, in Step S502, the operation panel 28 of the MFP 4 displays the retrieved MFPs 4a, 4b, and 4c in the form of a list. When the user operates the operation panel 28 to select an MFP of a transmission destination for the setting content from the above-mentioned list, the operation panel 28 accepts the selection, and the procedure advances to Step S503.

In Step S503, the data analysis unit 14 of the MFP 4 decides the setting content related to the transmission. Herein, the setting content, related to the transmission, may be only the setting content used upon the MFP 4 or may be the setting content of all of the setting items. Alternatively, the user may use the operation panel 28 to select the setting content related to the transmission from the used setting content.

Subsequently, in Step S504, the processing execution unit 16 generates a setting alteration request including the setting content decided in Step S503. The network interface 26 transmits this generated setting alteration request to the MFP of the transmission destination via the network 2, and the process is terminated.

Hereinabove, a description has been made of the process executed on the MFP 4 by referring to FIG. 5, but the same process can be executed on the MFP 4a, 4b, or 4c.

As described above, the system 1 according to this embodiment of the present invention is designed so that the plurality of MFPs 4, 4a, 4b, and 4c are connected to one another via the network 2 and a common setting alteration among those MFPs 4, 4a, 4b, and 4c can be executed.

Herein, while the setting alteration with respect to the MFP 4 is being performed, another setting alteration request is prevented. For example, while a setting alteration is being performed through the operation panel of the MFP 4a, the setting alteration performed through the operation panel 28 of the MFP 4 and the operation panel of the MFP 4b or 4c is prevented.

Therefore, even when there are setting alteration requests with respect to the MFP 4 made by the operation panels of a plurality of MFPs among the MFPs 4, 4a, 4b, and 4c within the same network 2, it is clear that MFP has performed the effective setting alteration. In addition, after that, the MFP (for example, MFP 4a) that is to be a reference used to share the setting content is clear. As a result, the system can be shared without failure among the MFPs 4, 4a, 4b, and 4c that are connected to one another via the network 2.

In this embodiment of the present invention, the setting alteration request may be made by the remote PC 6 instead of the operation panel 28. In this case, the setting alteration request is received by the network interface 26 from the remote PC 6 via the network 2.

Further, instead of the setting alteration request made by the operation panel 28, the setting alteration with respect to the MFP 4 may be performed by acquiring a desired setting content from the MFP 4a, 4b, or 4c. In this situation, a transmission source MFP is selected in Step S502 of FIG. 5 instead of a transmission destination MFP, and in Step S503, the setting content related to the reception are selected instead of the setting content related to the transmission. Then, in Step S504, the processing execution unit 16 generates a transmission request to receive the selected setting content, and the network interface 26 transmits the transmission request to the transmission source MFP. The network interface 26 receives the setting content transmitted according to the above-mentioned transmission request. The processing execution unit 16 saves the received setting content in the memory 30 or on the HDD 32, and uses the received setting content upon the MFP 4, and the process is terminated.

Further, in the process of FIG. 5, the transmission destination or the transmission source can be selected arbitrarily from the MFPs 4a, 4b, and 4c other than its MFP, but the MFP that has transmitted the setting content used upon the MFP 4 may be omitted from the candidates for the transmission destination or the transmission source.

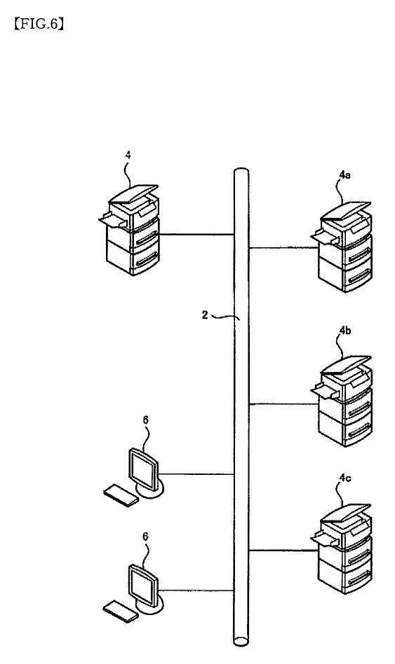

FIG. 6 is a configuration diagram of a device setting alteration system according to another embodiment of the present invention. The figure illustrates the system 1 designed by using, for example, the network 2 such as a LAN, in which image forming apparatuses (network devices) 4, 4a, 4b, and 4c and the remote PC (client device) 6 are each connected to the network 2.

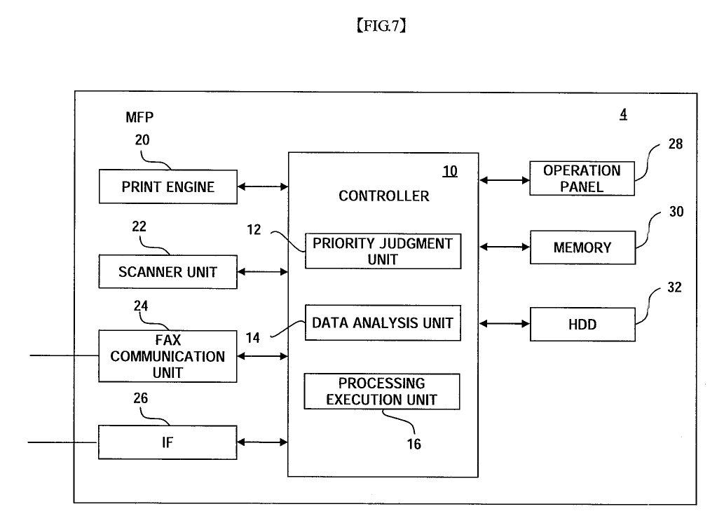

FIG. 7 is a schematic design diagram of the image forming apparatus. This image forming apparatus is a multiple function peripheral (MFP). Herein, MFPs 4, 4a, 4b, and 4c have the same design. Hereinafter, unless otherwise noted, the description is made by referring to the design of the MFP 4. The MFP 4 is connected to the network 2 by using a network interface 26, and is further connected to a public line. In addition, the MFP 4 executes various kinds of operation according to instructions issued by a program.

The MFP 4 includes a controller 10. The MFP 4 further includes an HDD 32, the network interface 26, a FAX communication unit 24, a scanner unit 22, a print engine 20, an operation panel 28, and a memory 30, which are each connected to the controller 10 via a bus.

In FIG. 7, the HDD 32, the network interface 26, the scanner unit 22, the print engine 20, the operation panel (device main body) 28, and the memory 30 have the same design as those of the previous embodiment of the present invention.

The various operations of MFP 4 are controlled by the controller 10. The controller 10 functions as a computer, and includes hardware resources such as a central processing unit (CPU). In addition, the controller 10 uses the hardware resources to execute a predetermined program, and operates the print engine 20, the scanner unit 22, and the FAX communication unit 24 which are described above.

The controller 10 includes a priority judgment unit 12, the data analysis unit 14, and the processing execution unit 16. The controller 10 according to another embodiment of the present invention preferentially performs either the setting alteration performed through the operation panel 28 or the setting alteration performed through the remote PC 6, and prevents the other setting alteration.

Note that examples of setting alterations include updating, deleting, and adding an email address included in the address book or a customer telephone number included in the customer information, and alteration of initial settings of a device.

Specifically, the controller 10 receives a setting alteration request made by the operation panel 28 via the bus. Further, the controller 10 also receives a setting alteration request made by the remote PC 6 via the network interface 26. Herein, the setting alteration requests made by the operation panel 28 and the remote PC include the command to perform a setting alteration, the identifier of the setting item to be altered, and the setting content thereof (such as the setting value and the setting character string).

The priority judgment unit 12 of the controller 10 determines whether the setting item to be altered for the MFP 4 corresponding to the setting alteration request is a setting item that requires an authentication ID or a setting item that needs to be shared by the MFPs within the same network 2. Based on that determination, the priority judgment unit 12 determines whether the setting alteration performed through the operation panel 28 or the setting alteration performed through the remote PC 6 is prioritized.

The priority judgment unit 12 outputs the determination result to the data analysis unit 14.

The data analysis unit 14 monitors whether or not there is currently a setting alteration request made by the operation panel 28 or the remote PC 6. The data analysis unit 14 outputs the result to the processing execution unit 16.

Based on the monitoring result output by the data analysis unit 14, the processing execution unit 16 determines whether one of the setting alterations performed through the operation panel 28 or the setting alteration performed through the remote PC 6 has been prioritized by the priority judgment unit 12. The processing execution unit 26 uses the prioritized setting alteration in the memory 30, the HDD 32, or the like when necessary. In contrast, the processing execution unit 16 prevents the other setting alteration that has not been prioritized from occurring.

Note that “the setting alteration performed through the operation panel 28” represents reflecting the setting content included in the setting alteration request made by the operation panel 28 upon the MFP 4 in terms of the setting item targeted by the setting alteration request. In the same manner, “the setting alteration performed through remote PC 6” represents the setting content included in the setting alteration request made by the remote PC 6 upon the MFP 4 with respect to the setting item targeted by the setting alteration request.

Hereinafter, a description of the operation of the MFP 4 having the above-mentioned design according to another embodiment of the present invention will be given.

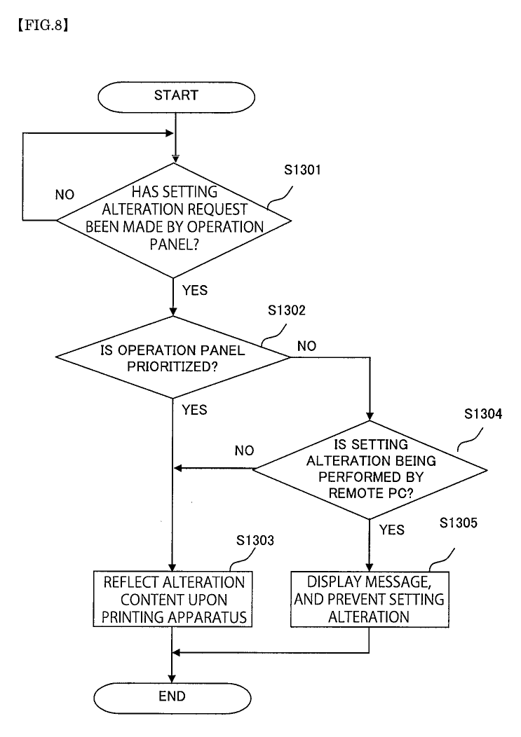

FIG. 8 is a flowchart illustrating a process for the setting alteration with respect to the MFP 4, which the device setting alteration program causes the controller 10 of the MFP 4 to execute, in the situation where a setting alteration request is made by the operation panel 28.

First, in Step S1301 of FIG. 8, the data analysis unit 14 waits until a setting alteration request made by the operation panel 28 of the MFP 4 is received. When a setting alteration request made by the operation panel 28 is received, the procedure advances to Step S1302.

Subsequently, in Step S1302, the priority judgment unit 12 determines whether or not the setting alteration performed through the operation panel 28 is to be prioritized according to the setting item corresponding to the setting alteration request made by the operation panel 28. Then, in a situation where the content of the current setting alteration is, for example, setting items that require an authentication ID, such as counter clearance and data deletion from the HDD 32, that is, when the determination results in “YES” the priority judgment unit 12 prioritize the setting alteration performed through the operation panel 28 regardless of whether or not the setting alteration is being performed through the remote PC 6, and the procedure advances to Step S1303.

Note that the phrase “a setting alteration is being performed through the remote PC 6” indicates that a setting alteration based on a setting alteration request from the remote PC 6 is being performed by the processing execution unit 16. More specifically, the phrase indicates the situation where a setting alteration request is intermittently received by the controller 10 from the remote PC 6 before and after the current setting alteration request received by the controller 10 from the operation panel 28, and the setting content in the setting alteration request are used by the processing execution unit 16 upon the MFP 4. In another embodiment of the present invention, the phrase indicates that when there is a setting alteration request received from the operation panel 28, a predetermined time period (for example, 1 minute) has not elapsed since the setting alteration request was received from the remote PC 6 (excluding a setting alteration request whose setting content has not been used upon the MFP 4). This situation includes the case where the predetermined time period has not elapsed since the occurrence of only one setting alteration request transmitted from the remote PC 6. However, it is possible that the subsequent setting alteration request may be made by the remote PC 6 within the predetermined time period, and hence in the anoter embodiment of the present invention, the data analysis unit 14 recognizes such a case as “the setting alteration is being performed through the remote PC 6”.

In Step S1303, the processing execution unit 16 uses the setting alteration performed through the operation panel 28 upon the MFP 4, and the process is terminated. Herein, the processing execution unit 16 alters the setting content in terms of the setting items that require the authentication ID, such as counter clearance and data deletion. For example, in the case of the counter clearance, the processing execution unit 16 changes the count value within the memory 30 to “000000” and in the situation of data deletion, changes the list of image data taken from the scanner unit 22 or the remote PC 6 onto the HDD 32.

Meanwhile, when it is determined in Step S1302 described above that the content of the current setting alteration do not prioritize the setting alteration performed through the operation panel 28, even when there is a setting alteration request made by the operation panel 28, that is, when the judgment results in “NO” the procedure advances to Step S1304.

In Step S1304, the data analysis unit 14 determines whether or not the setting alteration is being performed through the remote PC 6, and when the setting alteration is not being performed through the remote PC 6, that is, when the determination results in “NO” the procedure advances to Step S1303. In Step S1303, the processing execution unit 16 uses the setting alteration performed through the operation panel 28 upon the MFP 4, and the process is terminated. Herein, the processing execution unit 16 changes the setting content with respect to the setting items that do not require an authentication ID, such as a manually-fed paper sheet setting and a document size setting. For example, in the case of the manually-fed paper sheet setting, the processing execution unit 16 changes the manually-fed paper sheet size within the memory 30 and in the case of the document size setting, changes the document size within the memory 30.

In Step S1304, when the data analysis unit 14 determines that the setting alteration is being performed through the remote PC 6, that is, when the determination results in “YES” the procedure advances to Step S1305.

In Step S1305, the processing execution unit 16 prevents the setting alteration performed through the operation panel 28. Further, the processing execution unit 16 displays a message that reads, for example, “a setting alteration is currently being performed through the remote PC” on the operation panel 28 to prompt the user to abandon the setting alteration performed through the operation panel 28, and the process is terminated.

Note that when the determination performed by the data analysis unit 14 in Step S1304 results in “YES” the MFP 4 executes a process that is performed when determination performed in Step S1502 as described later results in “YES” or the determination performed in Step S1504 described later results in “NO”.

Incidentally, the remote PC 6 can perform the setting alteration for each of the MFPs 4, 4a, 4b, and 4c. The setting items that can be altered by the remote PC 6 include a setting item that needs to be shared by the plurality of MFPs. For example, such a setting item corresponds to a shared address book, customer information, or the like. The remote PC 6 can transmit a shared setting alteration request with respect to each MFP to thereby collectively perform setting alterations. Therefore, when the setting alteration is performed with respect to the setting item that needs to be shared by the plurality of MFPs, the setting alteration performed through the remote PC 6 may be prioritized.

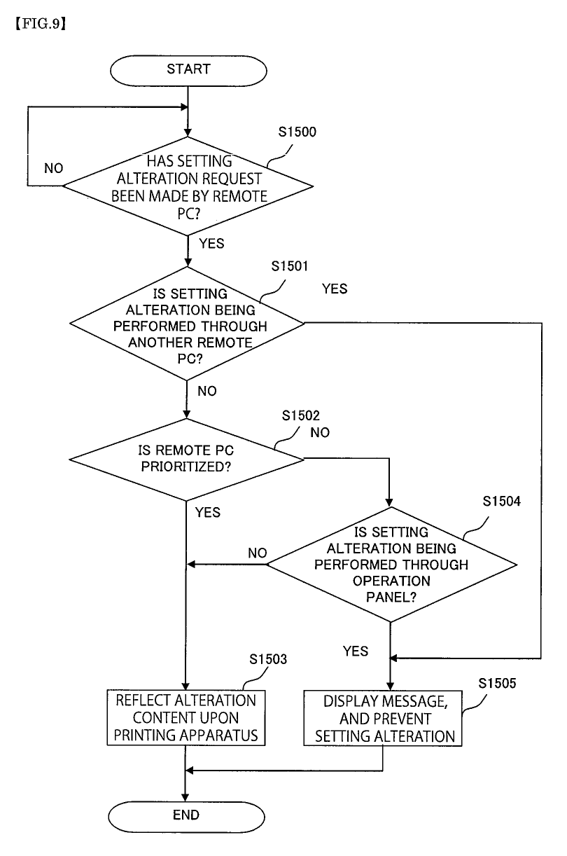

FIG. 9 is a flowchart illustrating a process for the setting alteration with respect to the MFP 4, where the device setting alteration program causes the controller 10 of the MFP 4 to execute, in the situation where a setting alteration request is made by the remote PC 6.

First, in Step S1500 of FIG. 9, the data analysis unit 14 waits until a setting alteration request made by the remote PC 6 is received. When the setting alteration request made by the remote PC 6 is received, the procedure advances to Step S1501.

In Step S1501, the data analysis unit 14 determines whether or not the setting alteration is being performed through another remote PC (not shown) with respect to the setting item that needs to be shared by the plurality of MFPs 4, 4a, 4b, and 4c. When the setting alteration is not being performed through another remote PC, that is, when the determination results in “NO” the procedure advances to Step S1502.

Note that the phrase “a setting alteration is not being performed through another remote PC” indicates that a setting alteration based on a setting alteration request from another remote PC is being performed by the processing execution unit 16. More specifically, the phrase indicates a situation where a setting alteration request is intermittently received by the controller 10 from another remote PC before and after the current setting alteration request received by the controller 10 from the remote PC 6, and the setting content in the setting alteration request is used by the processing execution unit 16 upon the MFP 4. In another embodiment of the present invention, the phrase indicates that when there is a setting alteration request received from the remote PC 6, a predetermined time period (for example, 1 minute) has not elapsed since the setting alteration request was received from another remote PC (excluding a setting alteration request whose setting content has not been used upon the MFP 4). This situation includes a case where the predetermined time period has not elapsed since the occurrence of only one setting alteration request transmitted from another remote PC. However, there is a possibility that the subsequent setting alteration request may be made by another remote PC within the predetermined time period, and hence in this embodiment of the present invention, the data analysis unit 14 determines that “the setting alteration is being performed by another remote PC”.

Subsequently, in Step S1502, the priority judgment unit 12 determines whether or not the setting alteration performed through the remote PC 6 is to be prioritized with respect to the setting item corresponding to the setting alteration request made by the remote PC 6. Then, in the situation where the content of the current setting alteration is, for example, setting items that need to be shared among the plurality of MFPs 4, 4a, 4b, and 4c, such as updating, deleting, and adding to the address book or the customer information, that is, when the determination results in “YES” the priority judgment unit 12 determines that the setting alteration performed through the remote PC 6 is to be prioritized regardless of whether or not the setting alteration is being performed through the operation panel 28, and the procedure advances to Step S1503.

Note that the phrase “a setting alteration is being performed through the operation panel 28” indicates that a setting alteration based on a setting alteration request from the operation panel 28 is being performed by the processing execution unit 16. More specifically, the phrase indicates the situation where a setting alteration request is intermittently received by the controller 10 from the operation panel 28 before and after the current setting alteration request received by the controller 10 from the remote PC 6, and the setting content in the setting alteration request are used by the processing execution unit 16 upon the MFP 4. In another embodiment of the present invention, the phrase indicates that when there is a setting alteration request received from the remote PC 6, a predetermined time period (for example, 1 minute) has not elapsed since the setting alteration request was received from the operation panel 28 (excluding a setting alteration request whose setting content has not been used upon the MFP 4). This situation includes a case where the predetermined time period has not elapsed since the occurrence of only one setting alteration request transmitted from the operation panel 28. However, it is possible that the subsequent setting alteration request may be made by the operation panel 28 within the predetermined time period, and hence in this embodiment of the present invention, the data analysis unit 14 determines that “the setting alteration is being performed through the operation panel 28”.

In Step S1503, the processing execution unit 16 uses the content of the setting alteration performed through the remote PC 6 upon the MFP 4, and the process is terminated. Herein, the process execution unit 16 changes the setting content in terms of the setting item that needs to be shared among the plurality of MFPs 4, 4a, 4b, and 4c, such as altering, deleting, or adding to the address book or the customer information. For example, the updating, deleting, or adding of an email address included in the address book within the HDD 32 or a customer telephone number included in the customer information within the HDD 32 is performed.

Meanwhile, when it is determined in Step S1502 described above that the content of the current setting alteration do not prioritize the setting alteration performed through the operation panel 28 even when there is access from the operation panel 28, that is, when the determination results in “NO” the procedure advances to Step S1504.

In Step S1504, the data analysis unit 14 determines whether or not the setting alteration is being performed through the operation panel 28, and when the setting alteration is not being performed through the operation panel 28, that is, when the determination results in “NO”, the procedure advances to Step S1503. In Step S1503, the processing execution unit 16 uses the setting alteration performed through the remote PC 6 upon the MFP 4, and the process is terminated. Herein, the processing execution unit 16 alters the setting content in terms of the setting items that are set for each MFP, such as the manually-fed paper sheet setting and the document size setting. For example, in the situation of the manually-fed paper sheet setting, the processing execution unit 16 changes the manually-fed paper sheet size within the memory 30, and in the case of the document size setting, changes the document size within the memory 30.

In Step S1504, when the data analysis unit 14 determines that the setting alteration is being performed through the operation panel 28, that is, when the determination results in “YES” the procedure advances to Step S1505.

As described above, the determination performed in Step S1501 or S1504 results in “YES” the procedure advances to Step S1505. In Step S1505, the processing execution unit 16 prevents the setting alteration performed through the remote PC 6. Further, the processing execution unit 16 generates a display request to display a message to the effect that the setting alteration has been prevented. The network interface 26 transmits the display request to the remote PC 6 which has been prevented from performing the setting alteration, and displays the message that reads, for example, “a setting alteration is currently being performed through the panel (or remote PC)” on an application screen of the remote PC 6, to prompt the user to abandon the setting alteration performed through the operation panel 28, and the process is terminated.

Note that when the determination performed by the data analysis unit 14 in Step S1504 results in “YES” the MFP 4 executes the process that is performed when determination performed in Step S1302 (described later) results in “YES” or the determination performed in Step S1304 (described later) results in “NO”.

As described above, the system 1 according to another embodiment of the present invention is designed so that the MFP 4 and the remote PC 6 are connected to each other via the network 2, and the setting alteration for the MFP 4 can be requested by both the operation panel 28 of the MFP 4 and the remote PC 6.

Herein, when either the setting alteration performed through the operation panel 28 or the setting alteration performed through the remote PC 6 is prioritized based on the content of the setting alteration for the MFP 4, the other setting alteration is prevented.

Further, when the priority judgment unit 12 determines that neither the setting alteration performed through the operation panel 28 nor the setting alteration performed through the remote PC 6 is prioritized, that is, when the determination results in “NO” in Steps S1302 and S1502, the earlier setting alteration request is adopted.

Therefore, even when the alteration is performed with respect to the same setting item at substantially the same time, it is that which one of the setting alterations performed through the operation panel 28 and the setting alteration performed through the remote PC 6 is effective. In addition, which setting alteration is effective is determined based on the content of the setting alteration for the MFP 4. As a result, the system is able to alter the setting item according to its importance compared to the related art that merely indicates a relationship between the remote PCs and does not clearly define a specific reference for determining which setting alteration is prioritized.

Further, in the situation where the content of the setting alteration for the MFP 4 is the setting items that require the authentication ID, for example, when the content is setting items of high importance, such as the counter clearance and the data deletion from the HDD 32, it is necessary to prevent unauthorized access without authentication. Therefore, in this situation, the setting alteration performed through the operation panel 28 is prioritized, while the setting alteration performed through the remote PC 6 is prevented, which contributes to an improvement in the reliability of the system 1.

In addition, in the situation where the content of the setting alteration for the MFP 4 is the setting items that need to be shared among the plurality of MFPs 4, 4a, 4b, and 4c, for example, in the situation where the content is the setting items that are of high importance with respect to sharing, such as updating, deleting, and adding to the address book or the customer information, the setting alterations for all of the MFPs (MFPs 4, 4a, 4b, and 4c) within the same network 2 need to be executed quickly and without fail. Therefore, in this situation, the setting alteration performed through the remote PC 6 is prioritized, while the setting alteration performed through the operation panel 28 is prevented, which also contributes to improvement in the reliability of the system 1.

Note that when the above-mentioned data analysis unit 14 is provided, it is also possible to monitor both present and past access, and hence data monitoring can be used effectively as other monitoring information.

In another embodiment of the present invention, when the setting items include a setting item that requires an authentication ID for performing a setting alteration and needs to be shared among a plurality of network devices, it may be set in the network device in advance whether the setting alteration performed through the device main body or the setting alteration performed through the client device is prioritized in terms of the above-mentioned item.

Further, when it is determined that the setting alteration performed through either the device main body or the client device is not prioritized, it may be determined that the other setting alteration must be prioritized.

Further, when the setting alteration performed through the device main body is not prioritized, the setting alteration performed through the operation panel may be prevented only while the setting alteration is being performed through the client device with respect to the same setting item as in the setting alteration request made by the device main body. Further, when the setting alteration performed through the client device is not prioritized, the setting alteration performed through the client device may be prevented only while the setting alteration is being performed by either the device main body or the client device with respect to the same setting item as in the setting alteration request made by the client device.

Further, another network device that is connected to the network device and is to be the subject of the setting alteration via a network may be set as the client device.

The present invention is not limited to the above embodiments, and various modifications can be made within the scope that does not depart from the scope of claims.

For example, the above-mentioned MFP 4 is an example of the image forming apparatus, and the present invention can, of course, be used with a copier, a printer, a facsimile machine, and the like. Further, the present invention can be used in a network device other than the image forming apparatus, for example, an automatic teller machine (ATM) and a ticket machine. That is, the present invention can be applied to those devices wherein it is necessary to update, delete, and add information on a user thereof or customer information, and/or alter the initial settings.

In part, in an embodiment, the present invention may be summarized as follows.

A device setting alteration system according to an embodiment of the present invention comprises a plurality of network devices connected to one another via a network. Each of the network devices comprises a device main body, a data analysis unit, a processing execution unit, and a network communication unit. Herein, the device main body requests a setting alteration with respect to its network device that comprises the device main body itself. When the device main body requests the setting alteration, the data analysis unit determines whether or not a setting alteration is being performed through another device main body of another network device. When the data analysis unit determines that a setting alteration is not being performed through another device main body, the processing execution unit uses the setting alteration performed through the device main body upon its network device. The network communication unit transmits a content of the setting alteration to another network device.

The above-mentioned device setting alteration system is designed so that the plurality of network devices are connected to one another via the network and the setting alteration with respect to each of those network devices can be executed.

Herein, when the setting alteration is not being performed through another device main body of another network device, the setting alteration request made by the device main body is adopted. With this fact, the content of the setting alteration performed through the device main body is used upon the network device, and are further transmitted to another network device. Accordingly, it can share the setting content among the plurality of network devices connected to one another via the network.

In addition to the above-mentioned configuration, when the content of the setting alteration is transmitted from another network device while the setting alteration with respect to its network device is being performed through the device main body, the processing execution unit may prevent the setting alteration performed through another device main body.

With such a design, the content of the setting alteration transmitted from another network device are never used upon the network device while the setting alteration is being performed through the device main body. This makes sure that the setting alteration performed through the device main body is effective. Further, when the setting content is to be shared after the reflection, it is clear that its network device is the reference.

In addition to the above-mentioned configuration, when the data analysis unit determines that the setting alteration is being performed through another device main body, the processing execution unit may prevent the setting alteration performed through the device main body.

With such a design, while the setting alteration is being performed through another device main body of another network device, it is possible to prevent the setting alteration performed through the device main body. With this fact, it is clear that the setting alteration performed through another device main body is effective. Further, when the setting content is to be shared after the reflection, it is clear that another network device is the reference.

In this situation, the network communication unit may receive the content of the setting alteration with respect to another network device transmitted from another network device, and the processing execution unit may reflect the received content of the setting alteration upon its network device.

With such a design, it is possible to reflect the setting content of another network device upon its network device, and to share the setting content.

Further, the network communication unit may transmit the content of the setting alteration which has been used on its network device by the processing execution unit to another network device other than its network device.

With such a design, it is possible to share the setting content among the plurality of network devices connected to one another via the network.

In addition, the network devices other than its network device may exclude another network device.

With such a design, the same setting content is never retransmitted to the network device of the transmission source of the setting content to be shared.

Further, in addition to the above-mentioned configuration, the processing execution unit may prevent a new setting alteration request while reflecting the setting alteration upon its network device.

With such a design, it is possible to prevent the settings of the network device from changing extremely rapidly.

A network device according to an embodiment of the present invention is connected to another network device via a network, and comprises a device main body, a data analysis unit, a processing execution unit, and a network communication unit. Herein, the device main body requests a setting alteration with respect to its network device that comprises the device main body itself. When the device main body requests the setting alteration, the data analysis unit determines whether or not a setting alteration is being performed through another device main body of another network device. When the data analysis unit determines that a setting alteration is not being performed through another device main body, the processing execution unit uses the setting alteration performed through the device main body upon its network device. The network communication unit transmits a content of the setting alteration to another network device.

With such a design, it is possible to share the setting content with another network device connected via the network.

A storage medium according to an embodiment of the present invention is a computer-readable storage medium which stores therein a device setting alteration program that causes a computer of a network device connected to another network device via a network to execute a setting alteration with respect to the network device. The device setting alteration program causes the computer to execute the steps of: requesting a setting alteration with respect to the network device; determining whether or not a setting alteration is being performed through another device main body when the setting alteration with respect to the network device is requested; reflecting, when it is determined that a setting alteration is not being performed through another device main body, the setting alteration performed through a device main body upon its network device; and transmitting a content of the setting alteration to another network device.

With such a configuration, it is possible to share the setting content with another network device connected via the network.

A device setting alteration system according to another embodiment of the present invention comprises a device main body, a client device, a priority judgment unit, and a processing execution unit. Herein, the device main body requests a setting alteration with respect to a network device. The client device is connected to the network device via a network, and requests a setting alteration with respect to the network device. The priority judgment unit determines whether the setting alteration performed through the device main body or the setting alteration performed through the client device is prioritized based on a content of the setting alteration with respect to the network device. The processing execution unit prevents another setting alteration when one setting alterations is determined to be prioritized by the priority judgment unit.

The above-mentioned device setting alteration system is designed so that the network device and the client device are connected to each other via the network and each of the device main body and the client device can request the setting alteration with respect to the network device.

Herein, either the setting alteration performed through the device main body or the setting alteration performed through the client device is prioritized based on the content of the setting alteration with respect to the network device. Then, when one of the setting alterations is prioritized, the other setting alteration is prevented.

Therefore, even when alterations of the same setting item are requested by the device main body and the client device with respect to the same setting item at substantially the same time, it is clear that one of the setting alterations is effective. In addition, which setting alteration is effective is determined based on the content of the setting alteration with respect to the network device. As a result, the system is able to alter setting item according to its importance.

In addition to the above-mentioned configuration, in the situation where the content of the setting alteration with respect to the network device are the setting items that require the authentication ID, the priority judgment unit may prioritize the setting alteration performed through the device main body regardless of whether or not the setting alteration is being performed through the client device.

With such a design, in the situation where the content of the setting alteration with respect to the network device is the setting items that require the authentication ID, the setting alteration performed through the device main body is prioritized, while the setting alteration performed through the client device is prevented. This can prevent the client device from performing unauthorized access without authentication, and contributes to improvement in the reliability of the system.

In addition to the above-mentioned configuration, in the situation where the content of the setting alteration with respect to the network device is not the setting items that require the authentication ID, a data analysis unit for determining whether or not the setting alteration is being performed through the client device may additionally be provided, and when the data analysis unit determines that the setting alteration is being performed through the client device, the setting alteration performed through the device main body may be prevented.

With such a design, in the situation where the content of the setting alteration does not require the authentication ID, the setting alteration can be performed through the device main body while ensuring the setting alteration performed through the client device, unless the setting alteration is being performed through the client device.

In addition to the above-mentioned design, in the situation where the content of the setting alteration with respect to the network device is the setting items that need to be shared among the plurality of network devices, the priority judgment unit may prioritize the setting alteration performed through the client device regardless of whether or not the setting alteration is being performed through the device main body.

With such a design, in the situation where the content of the setting alteration with respect to the network device is the setting items that need to be shared among the plurality of network devices, the setting alteration performed through the client device is prioritized, while the setting alteration performed through the device main body is prevented. This allows all of the setting alterations with respect to the network devices to be executed rapidly and without failure, and contributes to the improvement in the reliability of the system.

In addition to the above-mentioned design, in the situation where the content of the setting alteration with respect to the network device is not the setting items that need to be shared among the plurality of network devices, a data analysis unit for determining whether or not the setting alteration is being performed through the device main body or another client device may additionally be provided, and when the data analysis unit determines that the setting alteration is being performed through the device main body or another client device, the setting alteration performed through the client device may be prevented.

With such a design, in the situation where the content of the setting alteration does not need to be shared among the plurality of network devices, the setting alteration can be performed through the device main body while ensuring the setting alteration performed through the device main body or another client device, unless the setting alteration is being performed through the device main body or the client device.

A network device according to another embodiment of the present invention is connected to a client device via a network and comprises a priority judgment unit and a processing execution unit. The priority judgment unit determines whether a setting alteration performed through the device main body or a setting alteration performed through the client device is prioritized based on the content of the setting alteration with respect to the network device. The processing execution unit prevents another setting alteration when one setting alterations is determined to be prioritized by the priority judgment unit.

According to the above-mentioned network device, even when the alterations are requested by the device main body and the client device with respect to the same setting item at substantially the same time, it becomes clear that one of the setting alterations is effective. In addition, which setting alteration is effective is determined based on the content of the setting alteration with respect to the network device, thereby making it possible to alter the setting item according to its importance.

A computer-readable storage medium according to another embodiment of the present invention stores therein a device setting alteration program that causes a computer of a network device to execute a setting alteration with respect to the network device, the network device comprising a device main body and being connected to a client device via a network. The device setting alteration program causes the computer to execute the steps of: prioritizing either the setting alteration performed through the device main body or the setting alteration performed through the client device connected via the network based on the content of the setting alteration with respect to the network device; and preventing the other setting alteration when the one of the setting alterations is prioritized.

Using the above-mentioned storage medium, even when the alterations of the same setting item at substantially the same time are requested by the device main body and the client device in terms, it is clear that one of the setting alterations is effective. In addition, which setting alteration is effective is determined based on the content of the setting alteration with respect to the network device, thereby making it possible to alter the setting item according to its importance.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A device setting alteration system comprising:
a plurality of network devices connected to one another via a network,
each of the plurality of network devices comprising:
a device main body that requests a setting alteration with respect to its network device that comprises the device main body itself;
a data analysis unit that determines whether or not a setting alteration is being performed through another device main body of another network device when the device main body requests the setting alteration;
a processing execution unit that uses, when the data analysis unit determines that a setting alteration is not being performed through another device main body, the setting alteration performed through the device main body upon its network device; and
a network communication unit that transmits a content of the setting alteration to another network device.

2. The device setting alteration system according to claim 1, wherein the processing execution unit prevents the setting alteration performed through another device main body when the content of the setting alteration are transmitted from another network device while the setting alteration with respect to its network device is being performed through the device main body.

3. The device setting alteration system according to claim 1, wherein the processing execution unit prevents the setting alteration performed through the device main body when the data analysis unit determines that the setting alteration is being performed through another device main body.

4. The device setting alteration system according to claim 3, wherein:
the network communication unit receives the content of the setting alteration with respect to another network device transmitted from another network device; and
the processing execution unit uses the received content of the setting alteration upon its network device.

5. The device setting alteration system according to claim 4, wherein the network communication unit transmits the content of the setting alteration which has been used on its network device by the processing execution unit to another network device other than its network device.

6. The device setting alteration system according to claim 5, wherein another network device is not included in the network devices other than its network device.

7. The device setting alteration system according to claim 1, wherein the processing execution unit prevents a new setting alteration request while using the setting alteration upon its network device.

8. A network device, which is connected to another network device via a network, comprising:
a device main body that requests a setting alteration with respect to its network device that comprises the device main body itself;
a data analysis unit that determines whether or not a setting alteration is being performed through another device main body of another network device when the device main body requests the setting alteration;
a processing execution unit that uses, when the data analysis unit determines that a setting alteration is not being performed through another device main body, the setting alteration performed through the device main body upon its network device; and
a network communication unit that transmits a content of the setting alteration to another network device.

9. A computer-readable storage medium, which stores therein a device setting alteration program that causes a computer of a network device connected to another network device via a network to execute a setting alteration with respect to the network device,
the device setting alteration program causing the computer to execute the steps of:
requesting a setting alteration with respect to the network device;
determining whether or not the setting alteration is being performed through another device main body of another network device when the setting alteration with respect to the network device is requested;
using, when it is determined that a setting alteration is not being performed through another device main body, the setting alteration performed through a device main body upon the network device; and
transmitting a content of the setting alteration to another network device.

10. A device setting alteration system comprising:
a device main body that requests a setting alteration with respect to a network device;
a client device that is connected to the network device via a network, and requests a setting alteration with respect to the network device;
a priority judgment unit that determines whether the setting alteration performed through the device main body or the setting alteration performed through the client device is prioritized based on a content of the setting alteration with respect to the network device; and
a processing execution unit that prevents another setting alteration when one setting alteration is determined to be prioritized by the priority judgment unit.

11. The device setting alteration system according to claim 10, wherein when the content of the setting alteration with respect to the network device are setting items that require an authentication ID, the priority judgment unit prioritizes the setting alteration performed through the device main body regardless of whether or not the setting alteration is being performed through the client device.

12. The device setting alteration system according to claim 11, comprising a data analysis unit that determines whether or not the setting alteration is being performed through the client device when the content of the setting alteration with respect to the network device are not the setting items that require the authentication ID,
wherein the setting alteration performed through the device main body is prevented when the data analysis unit determines that the setting alteration is being performed through the client device.

13. The device setting alteration system according to claim 10, wherein when the content of the setting alteration with respect to the network device are setting items that need to be shared among a plurality of the network devices, the priority judgment unit prioritizes the setting alteration performed through the client device regardless of whether or not the setting alteration is being performed through the device main body.

14. The device setting alteration system according to claim 13, comprising a data analysis unit that determines whether or not the setting alteration is being performed through one of the device main body and another client device when the content of the setting alteration with respect to the network device are not the setting items that need to be shared among the plurality of the network devices,
wherein the setting alteration performed through the client device is prevented when the data analysis unit determines that the setting alteration is being performed through the one of the device main body and another client device.

15. A network device, which is connected to a client device via a network, comprising:
a device main body;
a priority judgment unit that determines whether a setting alteration performed through the device main body or a setting alteration performed through the client device is prioritized based on a content of the setting alteration with respect to the network device; and
a processing execution unit that prevents another setting alteration when one setting alteration is determined to be prioritized by the priority judgment unit.

16. A computer-readable storage medium, which stores therein a device setting alteration program that causes a computer of a network device to execute a setting alteration with respect to the network device, the network device comprising a device main body and being connected to a client device via a network,
the device setting alteration program causing the computer to execute the steps of:
prioritizing either the setting alteration performed through the device main body or the setting alteration performed through the client device connected via the network based on a content of the setting alteration with respect to the network device; and
preventing another setting alteration when the one setting alteration is prioritized.
